(19) United States
(12) Patent Application Publication
(10) Pub. No.: US 2025/0180841 A1
(43) Pub. Date: Jun. 5, 2025

(54) OPTICAL FIBER HAVING THIN COATING DIAMETER WITHOUT INCREASED MICROBEND SENSITIVITY

(71) Applicant: CORNING RESEARCH & DEVELOPMENT CORPORATION, Corning, NY (US)

(72) Inventors: Yunfeng Gu, Painted Post, NY (US); Ming-Jun Li, Horseheads, NY (US); Weijun Niu, Painted Post, NY (US); Sebastian Olszewski, Aleksandrów (PL); David Alan Seddon, Advance, NC (US); Darren Andrew Stainer, Wilmington, NC (US); Jeffery Scott Stone, Addison, NY (US)

(21) Appl. No.: 19/049,367

(22) Filed: Feb. 10, 2025

Related U.S. Application Data
(63) Continuation of application No. PCT/US2023/029916, filed on Aug. 10, 2023.
(60) Provisional application No. 63/397,045, filed on Aug. 11, 2022.

(51) Int. Cl. G02B 6/44; G02B 6/02

(52) U.S. Cl. CPC G02B 6/441; G02B 6/02395

(57) ABSTRACT

Embodiments of the disclosure relate to an optical fiber. The optical fiber includes a glass core and a glass cladding surrounding the glass core. The glass cladding defines a glass diameter of the optical fiber. A primary coating surrounds the glass cladding, and the primary coating has a first elastic modulus and a first thickness. A secondary coating surrounds the primary coating, and the secondary coating has a second elastic modulus and a second thickness. The second elastic modulus is greater than the first elastic modulus, and the second thickness is as thick or thicker than the first thickness. The optical fiber has an outer surface defining a fiber diameter in a range from 160 microns to 175 microns. The glass diameter of the optical fiber is in a range from 100 microns to 130 microns.

### CROSS-REFERENCE TO RELATED APPLICATIONS

This application is a continuation of International Application No. PCT/US2023/029916, filed on Aug. 10, 2023, which claims the benefit of priority of U.S. Provisional Application No. 63/397,045 filed on Aug. 11, 2022, the content of which is relied upon and incorporated herein by reference in its entirety.

### BACKGROUND OF THE DISCLOSURE

The present disclosure generally relates to optical fibers and optical fiber cables and in particular to optical fibers with small fiber diameters for use in optical fiber cables having a high fiber density.

High bandwidth and dense optical interconnects have attracted increased attention to accommodate the exponential growth of data center traffic. To increase the bandwidth of optical transmission links, systems with higher data rates and more wavelengths are being developed. Another dimension for increasing the bandwidth is to increase the core density in optical fibers and cables for example, through reducing the fiber diameter. One way to reduce fiber diameter is to reduce cladding diameter, and fibers with 80 micron glass diameters have been proposed as a way to increase fiber density. However, the reduced cladding diameter is not compatible with the existing ecosystem for standard single-mode fibers with 125 micron glass diameter and would require new field equipment and installation procedures for splicing and connectorization. Optical fibers may also contain coatings around the cladding that contribute to the fiber diameter, but reducing these coatings reduces the mechanical protection of the glass fiber and increases microbending sensitivity.

### SUMMARY OF THE DISCLOSURE

In one aspect, embodiments of the present disclosure relate to an optical fiber. The optical fiber includes a glass core and a glass cladding surrounding the glass core. The glass cladding defines a glass diameter of the optical fiber. A primary coating surrounds the glass cladding, and the primary coating has a first elastic modulus and a first thickness. A secondary coating surrounds the primary coating, and the secondary coating has a second elastic modulus and a second thickness. The second elastic modulus is greater than the first elastic modulus, and the second thickness is as thick or thicker than the first thickness. The optical fiber has an outer surface defining a fiber diameter in a range from 160 microns to 175 microns. The glass diameter of the optical fiber is in a range from 100 microns to 130 microns.

In another aspect, embodiments of the present disclosure relate to a subunit. The subunit includes a buffer tube having an interior surface and an exterior surface, and the interior surface defines a central bore having a buffer tube cross-sectional area (A_{Tube,ID}). The subunit also includes a plurality of optical fibers. Each optical fiber includes a core, a cladding surrounding the core, a primary coating surrounding the cladding, and a secondary coating surrounding the primary coating. Each optical fiber also has a fiber diameter in a range from 160 microns to 175 microns as measured at an outer surface of the optical fiber. The plurality of optical fibers has a total fiber area (A_{F}). The primary coating has a first elastic modulus and a first thickness, and the secondary coating has a second clastic modulus and a second thickness. The second thickness is equal to or greater than the first thickness, and the second elastic modulus is greater than the first elastic modulus. The buffer tube has a free space (100*(1-A_{F}/A_{Tube,ID}))) of at least 39%.

In still another aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable and a cable cross-sectional area (A_{C}). A plurality of buffer tubes (B) are disposed within the central cable bore, and each buffer tube of the plurality of buffer tubes includes an interior surface defining a buffer tube cross-sectional area (A_{Tube,ID}). A plurality of optical fibers (F) are disposed within each buffer tube of the plurality of buffer tubes. Each optical fiber of the plurality of optical fibers includes a fiber diameter of 160 microns to 175 microns as measured at an outer surface of the optical fiber. The plurality of optical fibers comprise a total fiber area (A_{F}), and the buffer tube has a free space (1-A_{F}/A_{Tube,ID}) of at least 39%. The optical fiber cable has a fiber density (B*F/A_{C}) of at least 5 fibers/mm².

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. In the drawings:

FIG. 1 is a cross-sectional view of a reduced coating diameter optical fiber, according to an exemplary embodiment;

FIG. 2 depicts a cross-sectional view of an optical fiber cable including a reduced coating diameter optical fiber, according to an exemplary embodiment;

FIG. 3 is a graph illustrating attenuation at 1550 nm as a function of force applied to the optical fiber in a sandpaper on a fixed drum test, according to an exemplary embodiment;

FIG. 4 depicts a graph of the slope of attenuation from the curves shown in FIG. 3 as a function of the thickness of the primary coating divided by the mode field diameter of the fiber, according to an exemplary embodiment;

FIG. 5 depicts a relative refractive index profile for a standard glass core and cladding, according to exemplary embodiments;

FIG. 6 depicts a relative refractive index profile for a glass core and cladding having a trench, according to exemplary embodiments;

FIG. 7 depicts attenuation at −30° C. for various reduced coating diameter optical fibers cabled in buffer tubes of varying free space, according to exemplary embodiments;

FIG. 8 depicts attenuation of two different 170 micron diameter fibers during thermal cycling testing at various free spaces within a buffer tube, according to exemplary embodiments;

FIG. 9 depicts attenuation of two different 160 micron diameter fibers during thermal cycling testing at various free spaces within a buffer tube, according to exemplary embodiments; and

FIGS. 10-12 provide graphs of free space as a function of buffer tube inner diameter for buffer tubes carrying 12, 24, and 36 fibers, respectively, at three different fiber diameters, according to exemplary embodiments.

### DETAILED DESCRIPTION

Embodiments of the present disclosure relate to an optical fiber having a small outer diameter and good microbending insensitivity and an optical fiber cable incorporating same. As mentioned above, there is a desire for higher density optical fiber cables, e.g., providing more optical fibers in a given package or providing the same number of optical fibers in a smaller package. Conventionally, the fiber density is increased by decreasing the free space in the optical fiber cable. However, the free space can only be decreased so far before the components of the cable abut each other, preventing further increases to density. According to the present disclosure, the size (i.e., outer diameter) of the optical fibers is decreased by decreasing the coating thickness of the optical fibers while the glass diameter (i.e., diameter of the glass core and glass cladding) is maintained with or close to the standard diameters of 125 μm to provide compatibility with current infrastructure. In order to maintain a requisite level of mechanical reliability of the optical fiber despite the decreased coating thickness, the secondary coating is made as thick or thicker than the primary coating. Further, to avoid microbending sensitivity, the free space within the cable is counterintuitively increased. That is, increasing free space is generally associated with a decreased fiber density, but according to the present disclosure, the fiber density is actually increased because the decrease in fiber diameter increases fiber density faster than the increase in free space decreases it.

Further, Applicant has found that, in cables with a minimum free space and fibers having a small fiber diameter in the range of 160 micron to 175 micron with a secondary coating as thick or thicker than the primary coating, the glass core and glass cladding can be made of conventional fiber materials. That is, previous attempts to decrease fiber diameter typically involved careful configuration of the refractive index profile of the glass core and glass cladding, or use of primary coating with lower elastic modulus to counteract microbending attenuation. Such optical fibers are difficult and expensive to produce, and while such fibers may be used according to embodiments of the present disclosure, they are not necessary. These and other aspects and advantages of the small diameter optical fibers and optical fiber cables including same will be described more fully below and in relation to the accompanying figures. The embodiments described herein are presented by way of illustration, not limitation.

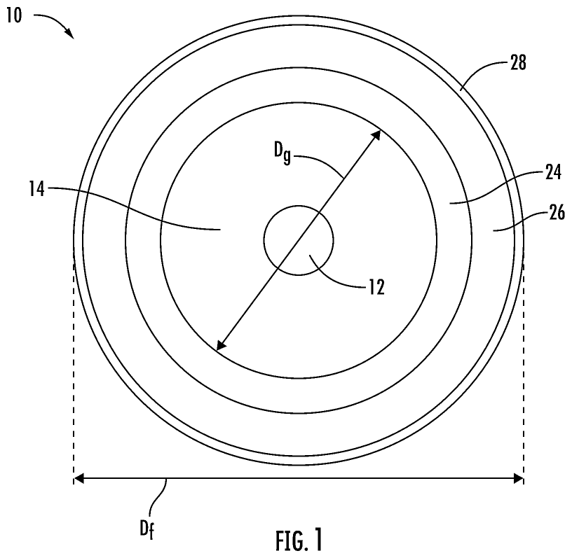

Referring to FIG. 1, an embodiment of an optical fiber 10 is depicted. In particular, a cross-sectional view taken perpendicular to a longitudinal axis of the optical fiber 10 is shown. The optical fiber 10 includes a core 12 surrounded by a cladding region 14. In one or more embodiments, the core 12 and cladding region 14 are comprised of a glass material. In one or more embodiments, the core 12 is comprised of germania-doped silica, and the cladding region 14 comprises a fluorine-doped silica that is doped in a manner such that a refractive index profile of the cladding region 14 is characterized by a trench, as will be described in greater detail below. In one or more embodiments, the refractive index profile of the core 12 may be a simple step index profile or graded index profile. In one or more embodiments, the cladding region 14 comprises a single cladding layer. In one or more embodiments, the cladding region 14 comprises dual cladding layers containing a depressed index inner cladding layer. In one or more embodiments, the cladding region 14 comprises three cladding layers with a depressed index cladding layer in the middle for improving microbending insensitivity. In one or more embodiments, a refractive index profile of the depressed index cladding layer is characterized by a refractive index trench that defines a square or triangle shape.

As used herein, a depressed index cladding region, also referred to as a trench region, is a portion of the cladding region 14 that has a lower refractive index than other portions of the cladding region 14.

In one or more embodiments, the core 12 has a first radius that is from 3.5 microns to 6 microns (i.e., a diameter of 7 microns to 12 microns). In one or more embodiments, the cladding region 14 has a second radius that is from 50 microns to 65 microns. The cladding region 14 defines a maximum cross-sectional dimension of the glass of the optical fiber 10, i.e., a glass diameter D_{g}. In one or more embodiments, the glass diameter D_{g} of the optical fiber 10 is from 100 microns to 130 microns, or from 120 microns to 130 microns, in particular 124 microns to 126 microns, and most particularly about 125 microns.

Disposed around the cladding region 14 are an inner primary coating 24 and an outer secondary coating 26. In one or more embodiments, the primary coating 24 directly contacts the cladding region 14, and the secondary coating 26 directly contacts the primary coating 24. In one or more embodiments, the inner primary coating 24 and the outer secondary coating 26 is configured to provide mechanical protection for the optical fiber 10. In one or more embodiments, the secondary coating 24 defines the outermost surface of the optical fiber 10. However, in one or more other embodiments, the optical fiber 10 further includes a color layer 28, which may be used to identify the optical fiber 10. In embodiments in which the color layer 28 is included, the color layer 28 may define the outermost surface of the optical fiber 10.

In one or more embodiments, the primary coating 24 and the secondary coating 26 are made from a curable resin, such as an acrylate. In one or more embodiments, the resin is UV-curable. In one or more embodiments, the composition of the primary coating 24 has a lower density of cross-links than the composition of the secondary coating 26. Various curable resins, including UV-curable acrylate resins, are commercially available and known to those of ordinary skill in the art. In one or more embodiments, the primary coating 24 has a first elastic modulus, and the secondary coating 26 has a second elastic modulus. The second elastic modulus is much greater than the first elastic modulus. In one or more embodiments, the first elastic modulus of the primary coating 22 is 5 MPa or less, in particular in a range from 0.65 MPa to 5 MPa. In one or more embodiments, the second clastic modulus of the secondary coating 24 is 0.5 MPa or more, 1 MPa or more, 5 MPa or more, 10 MPa or more, 100 MPa or more, 500 MPa or more, or 1000 MPa or more. In one or more embodiments, the primary coating 22 has an elastic modulus of 1 MPa or less and a T_{g} (glass transition temperature) of −20° C. or less, and the secondary coating 24 has a Young's modulus of 1500 MPa or greater and a T_{g} of 65° C. or greater.

The secondary coating 26 may be prepared from a composition that exhibits high clastic modulus. Higher values of elastic modulus may represent improvements that make the secondary coating better suited for small diameter optical fibers. More specifically, the higher values of clastic modulus enable use of thinner secondary coatings on optical fibers without sacrificing performance. Thinner secondary coatings reduce the overall diameter of the optical fiber and provide higher fiber counts in cables of a given cross-sectional area. The clastic modulus of secondary coatings prepared as the secondary coating composition may be equal to or greater than 1500 MPa, more particularly about 1800 MPa or greater, or about 2100 MPa or greater and about 2800 MPa or less or about 2600 MPa or less.

In one or more embodiments, the combined thickness of the inner primary coating 24 and the outer secondary coating 26 is in the range of 5-40 microns, or in the range of 10-35 microns, or in the range of 15-35 microns. In one or more embodiments, the coating 22 has a ratio of the thickness of the secondary coating 26 to the thickness of the primary coating 24 in the range of 1.0 to 1.7. According to one or more other embodiments, the ratio of the secondary coating 26 thickness to the primary coating 24 thickness may be in the range of 1.0 to 1.6, in the range of 1.0 to 1.5, in the range of 1.0 to 1.4, in the range of 1.0 to 1.3, in the range of 1.0 to 1.2, in the range of 1.0 to 1.1, in the range of 1.1 to 1.7, in the range of 1.1 to 1.6, in the range of 1.1 to 1.5, in the range of 1.1 to 1.4, in the range of 1.1 to 1.3, in the range of 1.1 to 1.2, in the range of 1.2 to 1.7, in the range of 1.2 to 1.6, in the range of in the range of 1.2 to 1.5, in the range of 1.2 to 1.4, in the range of 1.2 to 1.3, in the range of 1.3 to 1.7, in the range of 1.3 to 1.6, in the range of 1.3 to 1.5, in the range of 1.3 to 1.4, in the range of 1.4 to 1.7, in the range of 1.4 to 1.6, in the range of 1.4 to 1.5, in the range of 1.5 to 1.7, in the range of 1.5 to 1.6, or in the range of 1.6 to 1.7.

In one or more embodiments, the primary coating 24 may have a thickness in the range of 5 microns to 20 microns, or in the range of 7 microns to 15 microns, or in the range of 8 microns to 11 microns. In one or more embodiments, the secondary coating 26 may have a thickness in the range of 5 microns to 20 microns, or in the range of 7 microns to 15 microns, or in the range of 8 microns to 13 microns. In one or more embodiments, the color layer 28 may have a thickness of 10 microns or less, more particularly 8 microns or less, and more particularly in the range of 2 microns to 8 microns.

In one or more embodiments, the optical fiber 10 has an overall fiber diameter D_{f} of 175 microns or less. More specifically, in one or more embodiments, the overall fiber diameter D_{f} may be in the range of 160 microns to 175 microns.

Embodiments of the optical fibers 10 described herein are able to be drawn at a draw speed of 20 m/s or greater with a primary/secondary coating diameter variation of +/− 5 microns or less and primary/secondary coating concentricity in +/− 5 microns or less. In one or more embodiments, the draw tension during drawing of the optical fibers is from 70 grams to 100 grams. In one or more embodiments, the optical fibers 10 can be colored by the same off-line or in-line process as for standard fibers. Additionally, the optical fibers 10 can be cabled using the same cabling process as for standard fibers.

Embodiments of the optical fibers 10 disclosed herein provide several advantages. For example, the optical fibers 10 maintain the glass cladding diameter around the standard 125 micron glass cladding for compatibility with standard equipment and installation procedures. Further, the smaller diameter optical fibers allow for cable designs with higher fiber density and/or for cable miniaturization. In particular, reducing fiber diameter from the standard 242 microns to 160 microns reduces the fiber cross-sectional area by 59%, allowing for fiber density to be increased by 2.4 times. As will be discussed more fully below, the handleability and processibility of the 160 micron to 175 micron optical fibers is maintained as compared to standard 250 micron optical fibers. Specifically, the reduced coating diameter fibers can be colored and cabled using standard processes. Still further, no attenuation penalty on shipping spool was observed for both 160 micron to 175 micron optical fibers compared to standard 250 micron fiber. The reduced coating diameter fibers exhibited good microbending insensitivity, especially for those fibers including a region in the cladding characterized by a trench in the refractive index profile. Also, thinner coating and less coating material can lead to reductions in fiber fabrication cost.

Embodiments of the optical fibers disclosed herein are compatible with the G.652.D single mode fiber standards for mode field diameter (MFD), cable cutoff wavelengths, chromatic dispersion, and bending performance. In addition, for easy splicing and connectorization with low insertion loss, the MFD at 1310 nm is greater than 8.8 microns, in particular greater than 9.0 microns, and more particularly greater than 9.2 microns.

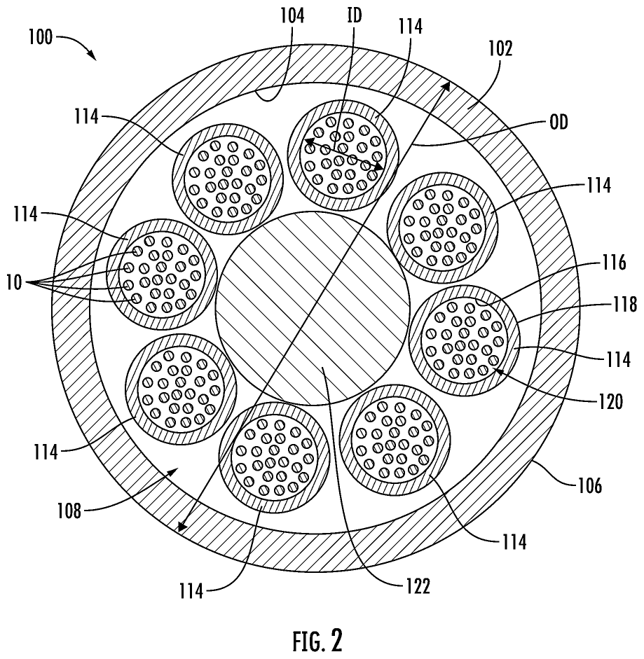

The optical fibers 10 described above are particularly suitable for use in high fiber density optical fiber optical fiber cables, such as the optical fiber cable 100 depicted in FIG. 2. In one or more embodiments, the optical fiber cable 100 includes a cable jacket 102 having an inner surface 104 and an outer surface 106. The inner surface 104 defines a central cable bore 108. In one or more embodiments, the outer surface 106 defines an outermost surface of the optical fiber cable 100. Further, in embodiments, the outer surface 106 defines an outer diameter OD of the optical fiber cable 100. In embodiments, the outer diameter OD of the optical fiber cable 100 is from about 4 mm to about 15 mm, in particular about 5 mm to about 10 mm, and particularly about 6 mm to about 9 mm.

Disposed within the central cable bore 108 are a plurality of optical fibers 10 as described above and as shown in FIG. 1. In the embodiment depicted, the optical fibers 10 are arranged in a loose tube configuration within a plurality of buffer tubes 114. Each buffer tube 114 has an interior surface 116 and an exterior surface 118. The optical fibers 10 are provided within a central buffer tube bore 120 defined by the interior surface 116 of the buffer tube 114. In one or more embodiments, each buffer tube 114 includes from twelve to thirty-six optical fibers 10. Further, in one or more embodiments, the optical fiber cable 100 includes from five to sixteen buffer tubes 114, in particular six to twelve buffer tubes 114.

In one or more embodiments, an optical fiber cable 100 so constructed may include, for example, from 60 to 576 optical fibers 10, in particular from 192 to 288 optical fibers 10. Based on the number of optical fibers 10 within the optical fiber cable 100 and the cross-sectional area of the optical fiber cable 100 perpendicular to the longitudinal axis of the optical fiber cable 100 (as defined by the outer diameter OD shown in FIG. 2), a fiber density can be calculated. In embodiments, the fiber density of the optical fiber cable is at least 5 fibers/mm², at least 6 fibers/mm², at least 6.8 fibers/mm², at least 7 fibers/mm², at least 7.7 fibers/mm², at least 8.5 fibers/mm², at least 9.5 fibers/mm², or at least 10.7 fibers/mm². In embodiments, the fiber density is up to 14 fibers/mm².

Table 1 illustrates example minimum and maximum fiber densities for optical fibers having the specified outer diameter (including color layer) having a cable construction as shown in FIG. 2. The variance in fiber density relates, e.g., to differences in optical fiber number and free space in the buffer tube. As can be seen, the fiber density increases with decreasing optical fiber outer diameter.

TABLE 1
Example Optical Fiber Cable Fiber Density
based on Fiber Outer Diameter

| Colored Fiber OD | Minimum Density | Maximum Density |
|---|---|---|
| (micron) | (fibers/mm²) | (fibers/mm²) |
| 208 | 4.5 | 6.4 |
| 190 | 5.4 | 7.6 |
| 180 | 6.1 | 8.5 |
| 170 | 6.8 | 9.5 |
| 160 | 7.7 | 10.7 |
| 150 | 8.7 | 12.2 |
| 140 | 10.0 | 14.0 |

In the embodiment depicted in FIG. 2, the buffer tubes 114 are disposed around a central strength member 122. In one or more embodiments, the central strength member 122 comprises glass-reinforced plastic rods, fiber-reinforced plastic rods, or metal strands, among others, which may be upjacketed with a layer of polymeric material. Further, in embodiments, the strength member 122 comprises a diameter of 0.5 mm to 1.5 mm, in particular 0.75 mm to 1.25 mm, more particularly about 1.2 mm.

Optical fiber cables 100 having optical fibers 10 arranged within buffer tubes 114 in a loose tube configuration are designed with a particular amount of free space. Free space within the buffer tube 114 is defined as

$$Free Space = 1 - \frac{{A}_{F}}{{A}_{Tube , ID}}$$

where A_{F} is the sum of the cross-sectional areas of all the optical fibers 10 in a single buffer tube 114, and A_{Tube,ID} is the cross-sectional area of the buffer tube 114 as measured from the interior surface 116 of the buffer tube 114. Free space within a buffer tube 114 provides room for the optical fibers 10 to move during bending without causing unacceptable attenuation.

Further, optical fiber cables 100 are designed with an amount of excess fiber length (EFL) in the optical fiber cable 100. In part, the EFL creates a tensile window for the optical fiber cable 100 such that, when a load is applied to the optical fiber cable 100, EFL allows for the strength member 122 in the optical fiber cable 100 to take some of the load before the optical fibers 10 begin to strain. In relatively small, high density optical fiber cables 100, EFL is generally minimized, approaching zero in certain designs. In such designs, free space in the tube is reduced to reduce the outer diameter (OD) of the optical fiber cable 100, and thus, there is little room for the excess fiber to accumulate.

During low temperature conditions, polymeric materials, which comprise the buffer tube and jacket, tend to shrink. When the cable (and buffer tube) shrinks, EFL is generated within the optical fiber cable. For cables with EFL at room temperature, the EFL in the cable gets even higher. For cables with near zero EFL at room temperature, some EFL is generated at low temperatures. The EFL relative to the buffer tube length accumulates in the buffer tube's free space. If the free space is insufficient to accommodate the additional fiber length, then fiber buckling can create macrobending, and pressure of the optical fibers against the interior surface of the buffer tube and against adjacent optical fibers can create microbending.

Optical fiber characteristics impact the amount of resulting attenuation. Lowering the optical fiber diameter generates more free space in a given optical fiber cable construction, and therefore allows for less attenuation at a given cold temperature. Improving bend performance allows the fiber to experience more buckling within a contracting buffer tube before attenuation results. Improved microbend performance allows the optical fiber to experience pressure against the interior surface of the buffer tube and adjacent fibers with a lower degree of attenuation.

However, free space in a buffer tube is inversely related to fiber density of a cable. For a given construction, as free space in a buffer tube is minimized, the buffer tube diameter is also minimized (assuming that the buffer tube thickness remains constant). This, in turn, minimizes the optical fiber cable diameter, which minimizes the cross-sectional area of the optical fiber cable and increases the fiber density.

### EXPERIMENTAL EMBODIMENT 1

In order to determine the optical performance of the disclosed optical fibers as compared to a conventional optical fiber, several samples of small diameter optical fibers according to the present disclosure were produced. In particular, the samples of optical fibers produced according to the present disclosure included a glass core and glass cladding of SMF-28® or SMF-28® Ultra profile designs (both available from Corning Incorporated, Corning, NY). The SMF-28® fiber has a step index core profile with a relative refractive index (Delta %) of the core of about 0.34% greater than the cladding, and a core diameter about 9 microns. The core is doped with germanium, and the cladding is pure silica. The SMF-28® Ultra fiber has a graded core index parabolic profile design, with a relative refractive index of the core of about 0.45% greater than the cladding, and a core diameter of 13 microns. The inner cladding is pure silica (relative refractive index of 0%) with a radius of about 12 microns, and an outer cladding that has a relative refractive index of about 0.03%. Fibers with a glass diameter (De) of 125 microns were drawn on a draw tower without a slow cooling device at a draw speed of 1 m/2 to 20 m/s. The optical fibers were coated with commercially available primary coating materials and secondary coating materials in the primary coating diameters (Dₚ) and secondary coating diameters (Dₛ) shown in Table 2, below. The fibers were characterized for cable cutoff wavelengths, MFDs, and attenuation. The results are summarized in Table 2. The fiber cable cutoff wavelength and MFD were measured using the standard fiber optic test procedures (FOTP). The attenuation was measured on the optical fiber wound on a standard shipping spool of 15 cm in diameter with 70 g winding tension.

TABLE 2
Measured cable cutoff wavelengths, MFDs and attenuation
of fibers with different coating diameters.

| | | | | Cable | 1310 nm | 1550 nm | 1310 nm | 1550 nm |
|---|---|---|---|---|---|---|---|---|
| Fiber profile | | | | Cutoff | MFD | MFD | Attenuation | Attenuation |
| Type | D_{g} | Dₚ | Dₛ | (nm) | (micron) | (micron) | (dB/km) | (dB/km) |
| SMF-28 | 115 | none | 125 | 1129 | 9.2 | 10.4 | 0.355 | 0.227 |
| SMF-28 | 125 | none | 132 | 1210 | 9.3 | 10.6 | 0.345 | 0.207 |
| SMF-28 | 125 | none | 140 | 1220 | 9.0 | 10.3 | 0.337 | 0.194 |
| SMF-28 | 125 | 133 | 142 | 1160 | 9.2 | 10.4 | 0.324 | 0.183 |
| SMF-28 Ultra | 125 | 140 | 160 | 1220 | 9.1 | 10.2 | 0.333 | 0.187 |
| SMF-28 Ultra | 125 | 145 | 175 | 1210 | 9.0 | 10.3 | 0.334 | 0.188 |
| SMF-28 Ultra | 125 | 190 | 242 | 1189 | 9.1 | 10.2 | 0.332 | 0.188 |

As shown in Table 2, each of the tested optical fibers included a glass diameter of 125 microns. Three of the optical fibers were not provided with a primary coating, and in those optical fibers, the secondary coating was applied directly around the cladding region. For those three optical fibers, the outer diameters (Dₛ) were 125 microns, 132 microns and 140 microns, respectively. In the next three optical fibers, a primary coating was provided around the cladding region. The optical fibers had primary coatings with thicknesses of 4 microns, 7.5 microns, and 10 microns, respectively. In those optical fibers, the secondary coatings had thicknesses of 4.5 microns, 10 microns, and 15 microns, respectively. The final optical fiber was a conventional optical fiber having a fiber diameter of 242 microns with a primary coating thickness greater than the secondary coating thickness (32.5 microns and 26 microns, respectively).

Table 2 shows that the cable cutoff wavelengths and MFD for the disclosed small diameter optical fibers are within the typical distributions of the conventional single-mode fiber, i.e. the cable cutoff wavelength between 1160 to 1260 nm, and the MFD between 8.8 to 9.5 microns. For the fibers with both the primary coating and the secondary coating, the attenuation is substantially similar to the conventional 250 micron coated fiber. For the optical fibers with single layer coatings with diameters of 140 microns and below, the attenuation increases slightly with the decrease of coating diameter, but still lower than 0.25 dB/km set by the standard. This increase in tension could be caused by the winding tension. Nevertheless, the attenuation is low enough for short length applications, such as connector jumpers and short reach transmission.

### EXPERIMENTAL EMBODIMENT 2

As mentioned above, the coating layers of the optical fiber provide mechanical protection for the optical fibers. Thus, because the coatings are thinner in the reduced coating diameter optical fibers according to the present disclosure, optical fiber mechanical reliability is one factor to consider. In optical fiber handling and cabling processes, optical fibers can experience high stress events and can break if flaws are weaker than a stress level. Proof testing is used to ensure that the fiber strength distribution has a minimum strength level. For terrestrial applications, the proof test stress is 700 MPa (100 kpsi), which is required for reduced diameter fibers.

To study the effects of thinner coating on fiber strength, optical fibers were made with the standard 125 micron glass diameter and different coating diameters and tested by running them through the proof test under the 100 kpsi. Table 3 shows break rate per km in the proof test.

TABLE 3
Fiber proof test results at 100 kpsi

| Coating diameter | Fiber length | |
|---|---|---|
| (mm) | (km) | Breaks/km |
| 140 | 15 | 0.7 |
| 160 | 200 | 0.08 |
| 170 | 200 | 0.06 |
| 242 | 100 | 0.04 |

For the optical fibers having fiber diameters of 160 microns and 170 microns, Table 3 shows that the break rate increases slightly to 0.08 and 0.06 breaks/km, respectively, compared to 0.04 breaks/km for the standard 242 micron coated fiber. The break rate of the 140 micron coated fiber is much higher, in particular by an order of magnitude.

While the proof test is primarily used to measure the glass strength, it does indirectly provide information on the damage resistance of the coating. These preliminary proof test results suggest that the reduced coating diameter fiber having fiber diameter of 140 microns may not provide sufficient protection to prevent damage during the 100 kpsi proof tests, while the reduced coating diameter fibers having fiber diameters of 160 microns and 170 microns appear promising.

The results of the proof test were confirmed with puncture resistance measurements. In particular, the fiber puncture test indicated that the puncture load for the 140 micron fiber was less than one half of the 160 micron fiber.

EXPERIMENTAL EMBODIMENT 3

In this example, three optical fibers having diameters of 160 microns and 170 microns (actual diameter was 165 microns, 166 microns, and 178 microns with color layers on each fiber) were drawn at 20 m/s. The fibers were made with SMF-28® Ultra profile design described above. The coating materials were commercially available primary and secondary coatings. A color layer was added off-line, and no issues were observed related to handleability in the offline coloring process.

The colored reduced coating diameter fibers were tested for microbend sensitivity using sandpaper on a fixed drum method. In this test, the fiber is wound on a drum at varying tension. The contact force between the fiber and the sandpaper is calculated based on the drum radius and fiber wind tension. FIG. 3 shows measured microbend loss as dependence of external force for fibers with different coating diameters. As can be seen in FIG. 3, fibers with smaller coating diameters have higher attenuation sensitivity to the external force. In particular, the attenuation increases more with increased force applied to the optical fiber.

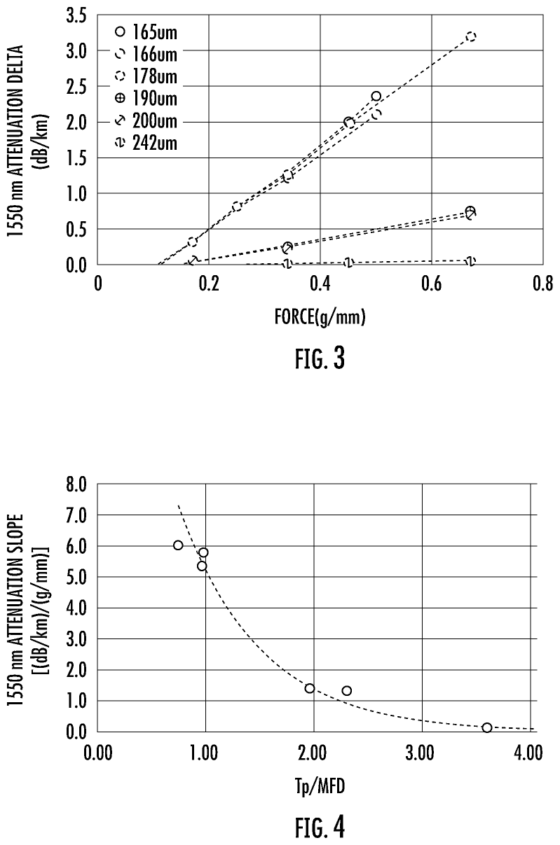

In this regard, though, the slope of the attenuation change with external force depends on both fiber refractive index profile designs and coating parameters. An analysis of the results suggest that the attenuation slope correlates with the ratio of the primary coating thickness (Tₚ) over the MFD as shown in FIG. 4. One way to reduce the attenuation slope is by increasing the primary coating thickness or by using a better primary coating material with lower clastic modulus. For example, a primary coating with an elastic modulus of less than 0.5 MPa, more preferably less than 0.3 MPa. The attenuation slope can also be reduced by using fiber designs with smaller MFD or using fiber design with a low index trench as used in bend insensitive fibers.

While the sandpaper on fixed drum test provides information regarding microbend performance of the fiber by itself, the actual microbend performance of an optical fiber in real cables depends on cable designs. In this regard, the test results in FIGS. 3 and 4 suggest that cable designs that minimize the external force applied to the fiber are important for high density cables using thin coated fibers. If the external force is less than 0.1 g/mm, the loss increase is negligible.

EXPERIMENTAL EMBODIMENT 4

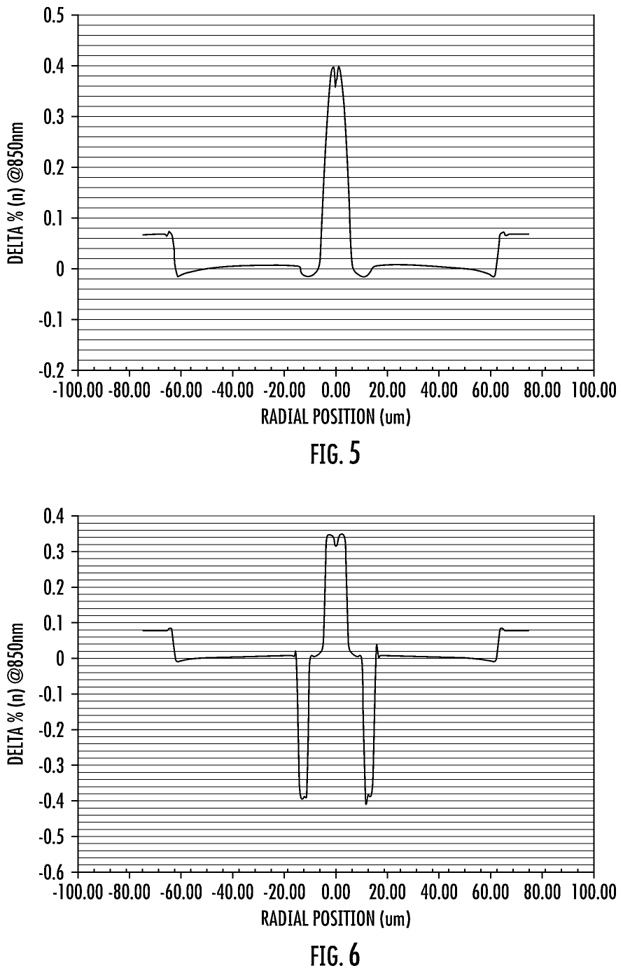

In this experimental design, four 160 micron and 170 micron fibers were made with either a SMF-28® Ultra profile described earlier or a profile design that includes a low index trench in the cladding to study handleability through coloring and cabling and to study impact of glass profile design on microbending performance through thermal cycle tests (TCT). A comparison of the refractive index can be seen in FIGS. 5 and 6. FIG. 5 depicts the refractive index profile for SMF-28® Ultra, and FIG. 6 depicts the refractive index profile of fibers made with a low refractive index trench region in the cladding. The profiles are shown in relative refractive index with a Delta % of 0 set in the cladding, and the profiles were measured using an interferometric fiber analyzer (IFA).

As shown in FIG. 5, the glass core has a relative refractive index of about 0.4% compared to the cladding material. Between the cladding and the core, there is a small dip in the relative refractive index of about 0.02%, and the cladding material has a substantially constant refractive index. The increase in relative refractive index at the edges of the profile corresponds to the index-matching oil that is used in the measurement.

In contrast to the profile of the SMF-28® Ultra, the refractive index profile of fibers made with a low refractive index trench region in the cladding, shown in FIG. 6, includes a deep trench in relative refractive index in the cladding. The relative refractive index of the core is about 0.35%. The relative refractive index drops substantially to 0% in a small first cladding region immediately adjacent to the core. Thereafter, the relative refractive index drops to about −0.38% in the low refractive index trench region of the cladding (i.e., a region of the cladding including dopants configured to yield the shown refractive index profile). Thereafter, the relative refractive index increases to 0% for the rest of the cladding until the index-matching oil is reached. In one or more embodiments, including the embodiment shown in FIG. 6, the cladding is provided with dopants in the refractive index trench region such that the trench in the refractive index profile is substantially rectangular (i.e., relatively sharp drop off, flat bottom region, and steep rise). However, in other embodiments the dopants may be provided such that the trench is triangular, having a gradual decline, a minimum point, and then a steep rise to the level of the remainder of the cladding. As mentioned above, the doping of the cladding to yield a low refractive index trench region enhances the microbend insensitivity, but such fibers are more complex and costly to produce.

In Table 4, below, the fibers FS170-1 and FS170-2 had glass diameters of 125 microns and were comprised of SMF-28® Ultra and the designs including a low refractive index trench region in the cladding, respectively. The primary coatings on these fibers had outer diameters of 145 micron (10 microns thick), and the secondary coatings on these fibers had outer diameters of 170 microns (12.5 microns thick). The fibers FS160-1 and FS160-2 also had glass diameters of 125 microns and were made of SMF-28® Ultra and the designs including a low refractive index trench region in the cladding, respectively. The primary coatings had outer diameters of 140 microns (7.5 microns thick), and the secondary coatings had outer diameters of 160 microns (10 microns thick). All of the fibers included commercially available primary and secondary coatings for commercial fiber products. The fibers were drawn at 20 m/s without a slow cooling device.

Table 4 lists the results of fiber geometry measurement. In Table 4, the glass diameter (D_{g}), primary coating diameter (Dₚ), secondary coating diameter (Dₛ), offset primary coating concentricity (OCₚ), and offset secondary coating concentricity (OCₛ) are given in microns.

TABLE 4
Geometry and coating concentricity of the
four 160 microns and 170 microns fibers

| | D_{g} | Dₚ | Dₛ | Dₛ:Dₚ | OCₚ | OCₛ |
|---|---|---|---|---|---|---|
| FS170-1 | 125.28 | 145.21 | 174.38 | 1.5 | 1.30 | 1.73 |
| FS170-2 | 125.29 | 147.85 | 175.48 | 1.2 | 2.37 | 2.20 |
| FS160-1 | 125.02 | 140.19 | 161.04 | 1.4 | 0.87 | 2.57 |
| FS160-2 | 125.34 | 139.77 | 161.71 | 1.5 | 0.25 | 1.53 |

As can be seen in Table 4, all fibers had coating diameters on the target of within +/− 5 microns. FS170-1 fiber had better coating concentricity than FS170-2, but FS160-2 fiber had better coating concentricity than FS160-1.

Table 5 shows the optical measurements for fibers FS170-1, FS170-2, and FS160-1 as compared to a control fiber. The control fiber was a conventionally sized optical fiber (SMF-28® Ultra optical fiber) having a glass diameter of 125 microns. The control fiber had a primary coating diameter of 190 microns and a secondary coating diameter of 242 microns (Dₛ/Dₚ=0.8).

TABLE 5
Measured Optical Parameters of Fibers
with Different Coating Diameters

| | Cable | 1310 nm | 1550 nm | 1310 nm | 1550 nm |
|---|---|---|---|---|---|
| Fiber | Cutoff | MFD | MFD | Attenuation | Attenuation |
| Code | (nm) | (micron) | (micron) | (dB/km) | (dB/km) |
| FS170-1 | 1212 | 9.2 | 10.3 | 0.337 | 0.190 |
| FS170-2 | 1261 | 9.2 | 10.3 | 0.332 | 0.191 |
| FS160-1 | 1204 | 9.2 | 10.2 | 0.337 | 0.189 |
| Control | 1205 | 9.2 | 10.2 | 0.337 | 0.190 |

Table 5 demonstrates that the cable cutoff wavelengths and MFD of the 160 and 170 micron fibers are within the typical distributions for standard single-mode fibers. Their attenuation is very similar to the control fiber with standard 242 micron coated diameter (uncolored fiber).

The fibers were also subjected to the sandpaper on a fixed drum microbend test as described above. The results of the test are shown in Table 6, below.

TABLE 6
Results of Sandpaper on Fixed Drum Microbending Test
Room Temperature 1550 nm Attenuation Delta

| Force | | | | | |
|---|---|---|---|---|---|
| (g/mm) | FS170-1 | FS170-2 | FS160-1a | FS160-2 | FS160-1b |
| 0.20 | 0.492 | 0.419 | 0.451 | 0.557 | 0.782 |
| 0.39 | 1.307 | 1.350 | 1.481 | 1.600 | 2.097 |
| 0.59 | 2.540 | 2.164 | 2.584 | 3.473 | 2.866 |

From Table 6, it can be seen that the optical fibers FS170-1, FS160-1a, and FS160-1b performed substantially according to the curves shown in FIG. 3, which used glass cores/claddings without trench refractive index profiles. FS170-2, which includes a cladding characterized by a trench refractive index profile, performed generally better than FS170-1 as expected. Thus, where a cable is deployed in conditions where microbending sensitivity is expected to be a significant issue, the use of the cost and complexity of using trench-refractive-index-profile fibers may be justified.

### EXPERIMENTAL EMBODIMENT 5

The fibers prepared in the preceding section were then colored by the offline process, and no breakage or other issues were observed. The colored fibers had overall diameter of either 166 microns or 180 microns. The attenuation on shipping spools was measured and found to be slightly increased by 0.002-0.017 dB/km as a result of attenuation dwell effect. The 160 micron fiber had more attenuation increase than the 170 micron fiber.

The colored fibers were cabled into a cable as shown in FIG. 2 along with two colored control fibers having fiber diameters of 190 microns and 200 microns with SMF-28® Ultra profile design and 190 microns with the trench-refractive-index-profile design. The buffer tubes in each of the cables were varied in terms of the amount of free space between 31% to 46%. That is, a cable was prepared including eight buffer tubes of each fiber type, and the eight buffer tubes in the cable varied in free space according to the sequence of 31%, 35%, 37%, 38%, 39%, 41%, and 46%. In preparing the cables, the reduced coating diameter fibers were able to be buffered, core stranded, and jacketed without any issues, again indicating good handleability of the 160 micron and 170 micron diameter fibers.

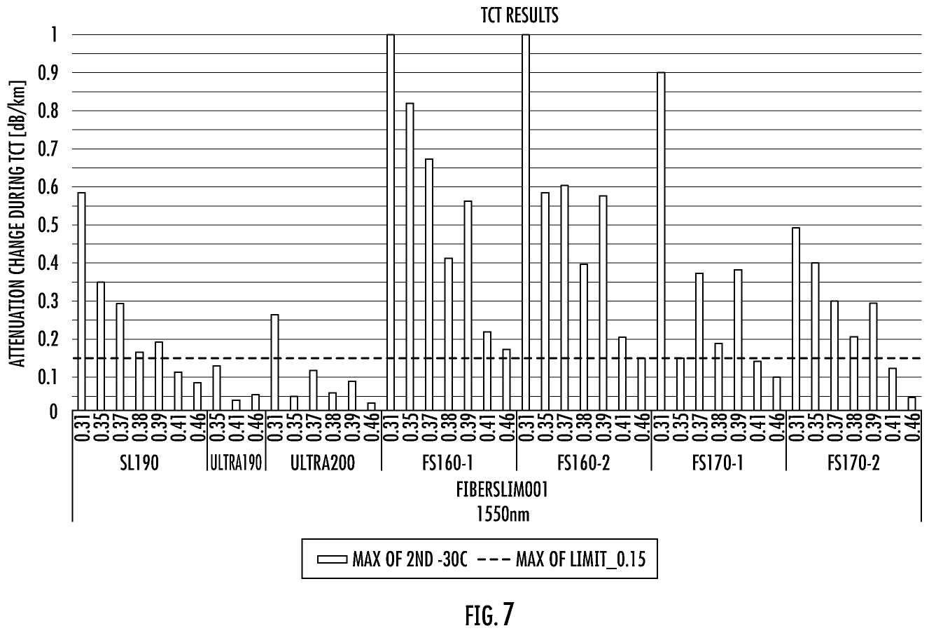

The cable attenuation at room temperature was measured and was within the specification of 0.25 dB/km at 1550 nm. As would be expected and as is shown in FIG. 7, the thermal cycle testing (TCT) showed that both the 160 micron and 170 micron fibers had more microbending than the 190 micron and 200 micron fibers. However, the inventors found that the free space within the buffer tube controlled whether the reduced coating diameter fibers were able to meet the relevant microbending attenuation standard of 0.15 dB/km at −30° C. In particular, the inventors found that, at certain free spaces within the buffer tube, both the 160 micron and 170 micron fibers could pass TCT tests. In the trial summarized in FIG. 7, the data showed that the 160 micron fiber passed −30° C. TCT test at a free space of 46% or higher, and the 170 micron fiber passed at free space of 41% or above. Therefore, a minimum fiber free space in the buffer tube for reduced coating diameter fibers allows for good low temperature performance.

The TCT testing shown in FIG. 7 also demonstrates that the optical fibers having a cladding characterized by a trench refractive index profile exhibited better microbend insensitivity than the fibers without a trench refractive index profile. FIG. 8 compares the attenuation change at 1550 nm during TCT of the 170 micron fibers including the SMF-28® Ultra and the trench-refractive-index-profile designs at different free space ratios. It can be seen that the 170 micron fiber with the trench design showed less attenuation change than the 170 micron fiber with SMF-28® Ultra design for all three free space ratios. At the free space of 41%, the 170 micron fiber with the trench design showed the attenuation change was below the maximum of the limit (0.15 dB/km), and the 170 micron fiber with the SMF-28® Ultra design hit the maximum of the limit. While the fibers having a trench-refractive-index-profile design in the trial performed better than optical fibers without a trench refractive index profile, the profile in the fibers had not been optimized. The inventors believe that, with a fiber having an optimized design of a trench refractive index profile (e.g., as controlled by doping of the cladding), the minimum free space can be expected to be as low as 39%.

### EXPERIMENTAL EMBODIMENT 6

Six 160 micron fibers were made according to three different designs for a second loose tube cabling trial. The fibers were drawn with a slow cooling device, and an improved trench refractive index profile design was used with the expectation of having better microbend insensitivity. The improved trench refractive index profile design was characterized by a slightly wider refractive index trench than that depicted in FIG. 6. The fibers were designed to have a range of MAC numbers, where MAC number is defined as the ratio of the mode field diameter to the cutoff wavelength in common units. A total of length of 300-400 km was drawn for each fiber, followed by the proof test at 100 kpsi. A significant screening improvement was observed with 0.02-0.03 breaks/km, which is similar to the break rate of fibers with the standard coating diameters of 190/242 micron. The attenuation loss on the shipping spools was 0.317-0.319 and 0.182-0.185 dB/km at 1310 nm and 1550 nm, respectively, which was similar to the standard production fibers with coating diameters of 190 microns and 200 microns, respectively. The application of a slow cooling device led to better attenuation performance than the fibers described in previous embodiments.

TABLE 7
Geometry and coating concentricity of three 160 micron fibers

| Fiber Code | Reel ID | D_{g} | Dₚ | Dₛ | Dₛ:Dₚ | OCₚ | OCₛ |
|---|---|---|---|---|---|---|---|
| Low MAC | 142-2733-1 | 125.45 | 138.89 | 165.30 | 2.0 | 0.57 | 1.98 |
| | 142-2733-2 | 125.53 | 140.26 | 164.25 | 1.6 | 0.56 | 1.75 |
| | 142-2733-3 | 125.14 | 141.18 | 163.39 | 1.4 | 0.50 | 1.55 |
| Nominal MAC | 142-2784-1 | 125.23 | 141.01 | 164.08 | 1.5 | 0.81 | 1.95 |
| High MAC | 142-2731-1 | 124.73 | 139.51 | 164.32 | 1.7 | 0.94 | 1.09 |
| | 142-2731-2 | 124.76 | 142.17 | 165.00 | 1.3 | 0.95 | 2.45 |

TABLE 8
Results of optical measurements for each of the three 160 micron fiber designs:

| | | | Mean | Mean | Mean | Mean | Mean |
|---|---|---|---|---|---|---|---|
| | Designed | Mean | Cable | 1310 nm | 1550 nm | 1310 nm | 1550 nm |
| | MAC | MAC | Cutoff | MFD | MFD | Attenuation | Attenuation |
| Fiber Code | number | number | (nm) | (micron) | (micron) | (dB/km) | (dB/km) |
| Low MAC | 7.31 | 7.37 | 1220 | 9.0 | 10.1 | 0.319 | 0.185 |
| Nominal MAC | 7.44 | 7.37 | 1224 | 9.0 | 10.2 | 0.319 | 0.182 |
| High MAC | 7.59 | 7.54 | 1236 | 9.3 | 10.5 | 0.317 | 0.182 |

As indicated in Table 8, the cable cutoff wavelengths and MFD of each of the three 160 micron fiber designs were within typical distributions for standard single-mode fibers. Further, their attenuations at 1310 nm and 1550 nm were very similar to the control fiber with standard 242 micron coated diameter as indicated by Tables 5 and 8. Due to a difference between designed MFD and measured MFD for the low MAC and nominal MAC fiber designs, these fibers had similar calculated MAC numbers.

The fibers were colored by an offline process, and no breakage or other issues were observed. The colored fibers had an overall diameter of 166-167 microns. The colored fibers were incorporated into a cable having a design with 8 buffer tubes and two buffer tube inner diameters (IDs), 1.265 mm and 1.24 mm. The 1.265 mm ID buffer tubes contained 24 fibers yielding 45% free space, whereas the buffer tube with ID 1.24 mm contained 25 fibers, yielding 40% free space.

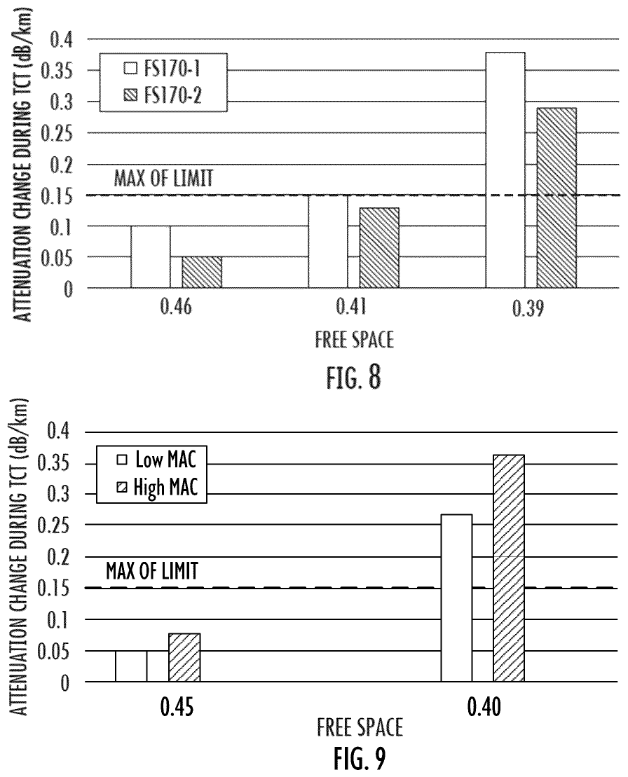

FIG. 9 depicts maximum attenuation changes of the 160 micron fibers at the two different free space levels during a TCT from −40° C. to 70° C. The TCT results show that the 160 micron fibers with 45% free space pass the −40° C. test with maximal attenuation increase below 0.10 dB/km at 1550 nm, meeting a target of <0.15 dB/km. On the other hand, the 160 micron fibers with 40% free space showed maximal attenuation increase of 0.37 and 0.27 dB/km at 1550 nm for high MAC and low MAC fibers, respectively. The low MAC fiber showed slightly lower attenuation increase than the high MAC fibers. As a comparison, SMF-28® Ultra 160 μm fibers in a buffer tube with a free space of 46% exhibited maximal attenuation change of 0.20 dB/km at 1550 nm at −40°° C. Therefore, core glass refractive index profile design can be used to improve the microbend performance for reduced coating diameter fibers in a loose tube cable.

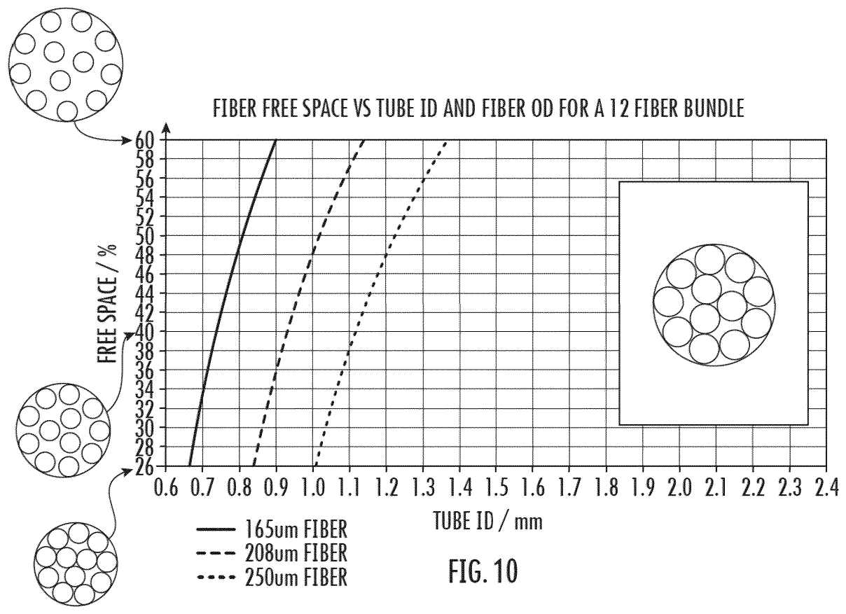

According to the present disclosure, embodiments of a reduced coating diameter fiber are provided, and such fibers are particularly suitable for high fiber density optical fiber cables. Because of the reduced coating diameter, provision is made to compensate for microbend sensitivity by increasing free space within the buffer tube. FIGS. 10-12 demonstrate that, despite the increase in free space, the buffer tubes can be made smaller than low free space buffer tubes carrying larger diameter fibers, thereby facilitating smaller and more fiber dense cable designs.

FIG. 10 shows fiber free space as a function of buffer tube IDs for three fiber outer diameters (OD). FIG. 10 considers the case of a buffer tube carrying twelve optical fibers in a loose tube configuration. In each case, the optical fiber is constructed of SMF-28® Ultra profile design and includes commercially available acrylate coating materials. On the left side of the graph, the density of the optical fibers within the buffer tube is shown to illustrate the free space. The minimum free space for circular optical fibers, in which the fibers are touching each other is 26%. At this minimum free space, a standard 250 micron fiber would require a buffer tube having a minimum diameter of about 1 mm. By comparison, a fiber having a diameter of 165 microns with a significantly higher free space of 40% would only require a buffer tube having an inner diameter of about 0.75 mm. Thus, despite the higher free space to compensate for microbending sensitivity, the buffer tube can be made smaller, leading to smaller cables overall and increased fiber density. Even for a reduced coating diameter of 208microns, the minimum free space in the buffer tube would still require an inner diameter of 0.87 mm. As mentioned above, the 160 micron fibers (165 with color layer) may require at least 45% free space, but the buffer tube inner diameter would still be only 0.77 mm.

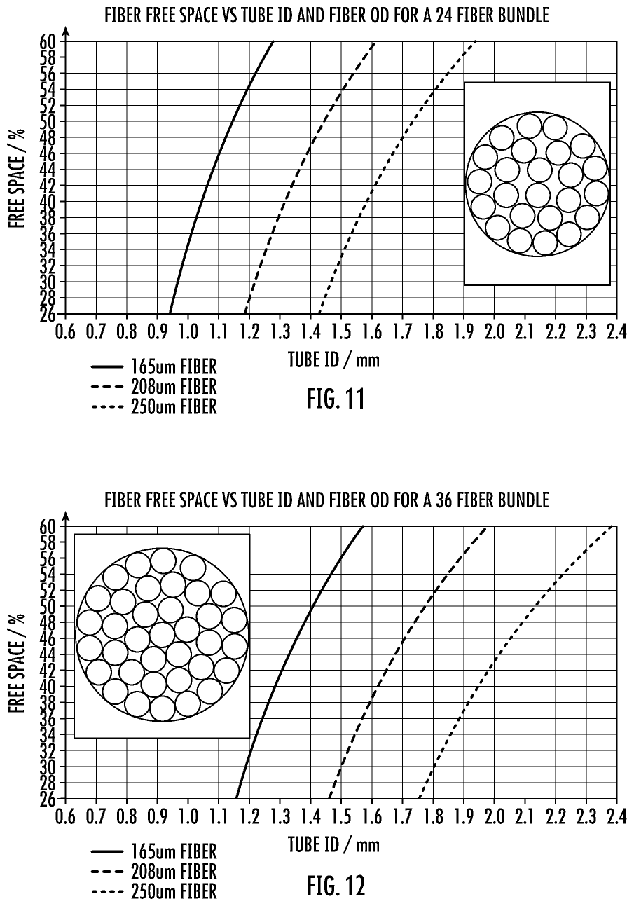

FIG. 11 provides a similar graph for buffer tubes carrying twenty-four optical fibers. Based on the TCT results shown in FIG. 7, a 200 micron reduced coating diameter fiber (208 micron with color layer) would require at least 31% free space to meet attenuation requirements at −30° C. At this free space, the buffer tube inner diameter would be 1.22 mm. For a 160 micron reduced coating diameter fiber according to the present disclosure (165 micron with color layer), the minimum free space required is 45%, but the buffer tube inner diameter only needs to be 1.0 mm, reducing the buffer tube size by 18%.

FIG. 12 provides still another similar graph for buffer tubes carrying thirty-six optical fibers. A 200 micron reduced coating diameter fiber provided with 31% free space would require a buffer tube inner diameter of 1.5 mm, whereas the 160 micron reduced coating diameter fiber according to the present disclosure requires only a buffer tube inner diameter of 1.35 mm, reducing the buffer tube size by 10%.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber, comprising:
a glass core;
a glass cladding surrounding the glass core, the glass cladding defining a glass diameter of the optical fiber;
a primary coating surrounding the glass cladding, the primary coating having a first elastic modulus and a first thickness; and
a secondary coating surrounding the primary coating, the secondary coating having a second elastic modulus and a second thickness;
wherein the second elastic modulus is greater than the first elastic modulus;
wherein the second thickness is as thick or thicker than the first thickness;
wherein the optical fiber has an outer surface defining a fiber diameter in a range from 160 microns to 175 microns; and
wherein the glass diameter of the optical fiber is in a range from 120 microns to 130microns.

2. The optical fiber of claim 1, wherein a ratio of the second thickness to the first thickness is in a range from 1.0 to 1.7.

3. The optical fiber of claim 1, wherein glass core is a germania-doped silica core and the glass cladding comprises a fluorine-doped silica trench region.

4. The optical fiber of claim 3, wherein the fluorine-doped silica trench region is characterized by a rectangular refractive index profile trench.

5. The optical fiber of claim 3, wherein the fluorine-doped silica trench region is characterized by a triangular refractive index profile trench.

6. The optical fiber of claim 1, wherein the first elastic modulus is in a range from 0.65 MPa to 5 MPa.

7. The optical fiber of claim 1, wherein the second elastic modulus is at least 1500 MPa.

8. A subunit, comprising:
a buffer tube comprising an interior surface and an exterior surface, the exterior surface defining a central bore having a buffer tube cross-sectional area (A_{Tube,ID});
a plurality of optical fibers, each optical fiber comprising:
a core,
a cladding surrounding the core,
a primary coating surrounding the cladding,
a secondary coating surrounding the primary coating, and
a fiber diameter in a range from 160 microns to 175 microns as measured at an outer surface of the optical fiber;
wherein the plurality of optical fibers comprises a total fiber area (A_{F});
wherein the primary coating comprises a first elastic modulus and a first thickness and the secondary coating comprises a second elastic modulus and a second thickness;
wherein the second thickness is equal to or greater than the first thickness and the second elastic modulus is greater than the first elastic modulus; and
wherein the buffer tube comprises a free space (100*(1-A_{F}/A_{Tube,ID})) of at least 39%.

9. The subunit of claim 8, wherein the cladding comprises a trench region having a relative refractive index of at least 0.2% lower than a rest of the cladding.

10. The subunit of claim 9, wherein a refractive index profile of the trench region is rectangular or triangular.

11. The subunit of claim 8, wherein the fiber diameter is less than 165 microns and wherein the free space is at least 45%.

12. The subunit of claim 8, wherein the cladding comprises a relative refractive index that varies by less than +/− 0.05%, wherein the fiber diameter is at least 170 microns, and wherein the free space is at least 41%.

13. The subunit of claim 8, wherein the cladding comprises a diameter in a range from 100 microns to 130 microns.

14. The subunit of claim 8, wherein a ratio of the second thickness to the first thickness is from 1.2 to 1.5.

15. An optical fiber cable, comprising:
a cable jacket comprising an inner surface and an outer surface, the inner surface defining a central cable bore and the outer surface defining an outermost surface of the optical fiber cable and a cable cross-sectional area (A_{C});
a plurality of buffer tubes (B) disposed within the central cable bore, each buffer tube of the plurality of buffer tubes comprising an interior surface defining a buffer tube cross-sectional area (A_{Tube,ID});
a plurality of optical fibers (F) disposed within each buffer tube of the plurality of buffer tubes;
wherein each optical fiber of the plurality of optical fibers comprises a fiber diameter of 160 microns to 175 microns as measured at an outer surface of the optical fiber;
wherein the plurality of optical fibers comprise a total fiber area (A_{F});
wherein the buffer tube comprises a free space (1-A_{F}/A_{Tube,ID}) of at least 39%; and
wherein the optical fiber cable comprises a fiber density (B*F/A_{C}) of at least 5 fibers/mm².

16. The optical fiber cable of claim 15, wherein each optical fiber of the plurality of optical fibers comprises a core, a cladding surrounding the core, a primary coating surrounding the cladding, and a secondary coating surrounding the primary coating; and
wherein the cladding comprises a diameter of 100 microns to 130 microns.

17. The optical fiber cable of claim 16, wherein the cladding comprises a trench region in which a relative refractive index is at least 0.2% lower than a rest of the cladding.

18. The optical fiber cable of claim 17, wherein the fiber diameter is 165 microns or less and wherein the free space is at least 45%.

19. The optical fiber cable of claim 16, wherein a relative refractive index of the cladding varies by less than 0.05%, wherein the fiber diameter is at least 170 microns, and wherein the free space is at least 41%.

20. The optical fiber cable of claim 16, wherein the primary coating comprises a first elastic modulus and a first thickness, wherein the secondary coating comprises a second elastic modulus and a second thickness, wherein the second elastic modulus is greater than the first elastic modulus, and wherein the second thickness is equal to or greater than the first thickness.

21. The optical fiber cable of claim 20, wherein a ratio of the second thickness to the first thickness is 1.0 to 1.7.
